(19) United States
(12) Patent Application Publication
(10) Pub. No.: US 2026/0159077 A1
(43) Pub. Date: Jun. 11, 2026

(54) Autonomous Machine Safety Integrity System

(71) Applicant: Applied Electric Vehicles Ltd, Scoresby (AU)

(72) Inventor: Marc Alexander, Croydon Hills (AU)

(73) Assignee: Applied Electric Vehicles Ltd, Scoresby (AU)

(21) Appl. No.: 18/975,463

(22) Filed: Dec. 10, 2024

(51) Int. Cl. B60W 30/09; B60W 50/02; B60W 60/00

(52) U.S. Cl. CPC B60W 30/09; B60W 50/0205; B60W 60/0015

(57) ABSTRACT

An autonomous machine safety integrity system is described. A central control unit having a threshold safety certification level uplifts subsystems of the autonomous machine into the threshold safety certification level. To do so, the central control unit injects services into the autonomous machine subsystems via Application Programming Interfaces (APIs) provided by the central control unit. Each API provided by the central control unit includes a safety integrity library that causes the central control unit to react by taking corrective action in response to a fault associated with one or more subsystems. Corrective action includes issuing an actuation command to an autonomous machine subsystem, cutting power to a subsystem, stopping the machine, or causing the machine to perform a minimum risk maneuver.

### BACKGROUND

Vehicle design necessitates integration of multiple components and systems, each contributing to the overall functionality and performance of the vehicle. These components and systems are often designed and manufactured by various specialized entities. Consequently, the disparate vehicle elements are susceptible to a range of fault causes and exhibit varying failure rates, depending on their respective designs, materials, and manufacturing processes. This variability in reliability and performance presents a significant challenge in vehicle design, as comprehensive risk assessment and mitigation is required to ensure proper vehicle operation and safety.

### BRIEF DESCRIPTION OF THE DRAWINGS

FIG. 1 illustrates an example environment in which a central control unit of a vehicle system uplifts a safety integrity level of at least one other unit of the vehicle system.

FIG. 2 is a block diagram of a non-limiting example of a vehicle system that implements the central control unit to uplift a safety integrity level of at least one other unit of the vehicle system.

FIG. 3 depicts an example block diagram a high-integrity safety level unit of a vehicle imparting the high-integrity safety level on other units of the vehicle.

FIG. 4 depicts a procedure in which a central control unit of a vehicle imparts a safety integrity level on a controlling unit of the vehicle.

FIG. 5 depicts a procedure in which a central control unit of a vehicle imparts a safety integrity level on a controlled unit of the vehicle.

### DETAILED DESCRIPTION

Safety remains a paramount concern in vehicle design. To ensure that vehicles satisfy minimum safety thresholds, various jurisdictions define safety requirements and prohibit vehicles from operating in public (e.g., on roadways with other vehicles) unless the vehicles have demonstrated compliance with the safety requirements. Many jurisdictions adopt international standards for defining vehicle safety requirements, such as the Automotive Safety Integrity Level (ASIL) risk classification scheme defined by the International Organization for Standardization (ISO).

The ASIL ratings range from ASIL-A to ASIL-D, where ASIL-A represents the least stringent safety requirements and ASIL-D represents the most stringent safety requirements (e.g., an ASIL-D certified vehicle represents a vehicle having a greatest level of risk reduction under the ISO risk classification scheme). ASIL ratings are applied to ensure that vehicles and automotive systems are designed and manufactured to operate safely and reliably under a range of different conditions in which the vehicle might operate. Under the ASIL risk classification scheme, individual components of a vehicle must be individually assessed to identify their respective Failure-in-Time (FIT) rates, where a FIT rate measures the expected number of failures per billion hours of operation. Under some ASIL iterations, achieving an ASIL-D certification for a vehicle component requires demonstrating that the component experiences less than ten unmitigated safety violations over one billion hours of operation (e.g., achieves a 10FIT rating).

Designing and manufacturing a single component to achieve an ASIL-D rating is challenging, as doing so requires that the component's design reliably and consistently operates with an extremely low probability of failure, which requires high-integrity safety mechanisms, redundancy measures, fault tolerances, rigorous testing processes, and so forth. These challenges are compounded when certifying complex vehicle components, such as drive units used to autonomously control vehicle motion, central control units configured to ensure vehicle safety by managing various controllable units of the vehicle, and so forth. Achieving an ASIL-D rating for an integrated vehicle system, which involves combining multiple components, each with different FIT rates, presents additional difficulties, as a single high-FIT component can preclude the system's ability to achieve ASIL-D.

Even integrating multiple low-FIT components into a vehicle presents problems for achieving an ASIL-D rating, as different components that are susceptible to a common cause failure are required to sum their FIT rates for ASIL certification. As an example, consider an instance where different steering control units made by a common manufacturer each achieve a 10FIT rating by individually demonstrating six safety violations per billion hours. Because the individual steering control units are susceptible to failure by a common cause (e.g., due to their common manufacturer and identical components), ASIL certification requires summing the respective FIT rates, which results in a 12FIT rating for the steering control units, thus disqualifying the vehicle from being certifiable at a 10FIT threshold for ASIL-D. Designing and manufacturing a vehicle that achieves an ASIL-D certification level thus remains a challenge, particularly in the context of autonomous vehicles, which include significantly more units that participate in vehicle control relative to conventional vehicles that rely on mechanical controls such as cable-actuated throttles and brakes.

Accordingly, an autonomous machine safety integrity system is described. In accordance with aspects of the systems and techniques described herein, a central control unit having a threshold safety certification level (e.g., a central control unit having an ASIL-D certification level) is configured to uplift controlling units (e.g., an autonomous driver unit) as well as controlled units (e.g., traction control motors, steering control motors, etc.) into the threshold safety certification level. Advantageously, the described systems and techniques enable the central control unit to impart the threshold safety certification level on controlling and controlled units of the vehicle, despite individual ones of the controlling elements and controlled units not having achieved the respective threshold safety certification level. To do so, the central control unit injects services into the respective units (e.g., injects services into individual controlling units and individual controlled units) via Application Programming Interfaces (APIs) provided by the central control unit.

In implementations, the central control unit provides at least one of a drive API or a safety API to individual units of a vehicle, based on a unit type. For instance, in the context of a controlling unit the central control unit provides both the drive API and the safety API via a link that communicatively couples the central control unit with the controlling unit. As described in further detail below, a controlling unit refers to a human machine interface, a remote control device, software-based control devices (e.g., advanced driver assistance systems (ADAS), artificial intelligence (AI)-based autonomous driver systems, programmatic-based autonomous driver systems, etc.), or combinations thereof.

Generally, the drive API enables the controlling unit to control motion of the vehicle by issuing one or more vehicle control commands to the central control unit (e.g., for routing to one or more controlled units of the vehicle). As a specific example, the drive API enables a controlling unit (e.g., a human machine interface directed by manual input, an autonomous driver unit, or a combination thereof) to adjust a motion path of the vehicle by transmitting a vehicle control command to the central control unit, which the central control unit routes as an actuation command to one or more steering control units of the vehicle. Generally, the safety API includes an integrated safety integrity library that tasks an edge device (e.g., the controlling unit) connected to the central control unit to with servicing defined calls to inform the central control unit of the edge device's health status.

As described in further detail below, the safety integrity library integrated into the safety API is compiled into the edge device upon boot-up (e.g., at each power cycle of the edge device) and causes the edge device to continuously (e.g., at one or more defined intervals) update the central control unit with data describing a health status of the edge device. Advantageously, and in contrast to conventional reporting watchdog services that merely broadcast status updates without invoking a reaction, respective safety integrity libraries of the drive API and the safety API are also compiled into the central control unit, which causes the central control unit to react in response to detecting a fault associated with one or more edge devices.

In this manner, by compiling the safety integrity libraries of the drive API and the safety API on both the central control unit and an edge device communicatively coupled to the central control unit (e.g., a controlling device or a controlled device), the central control unit causes an edge device to execute defined hooks and services that trigger reporting data to the central control unit. In implementations, the specific hooks and services included in the safety integrity libraries of the drive API and the safety API provided by the central control unit are configured based on one or more functionalities of the edge device. For instance, consider an example scenario where an edge device is configured as an autonomous driver unit.

In this example scenario, the safety integrity libraries of the drive API and the safety API cause the autonomous driver unit to service defined calls informing the central control unit that the autonomous driver unit has booted up, whether one or more defined checksums have passed as part of initializing the autonomous driver unit (e.g., following a power cycle), and so forth. During operation of the vehicle, the safety integrity libraries of the drive API and the safety API cause the autonomous driver unit to provide data that is useable by the central control unit to perform checks on the autonomous driver unit, such as boundary checks on values defining a motion path provided by the autonomous driver unit, threshold checks on motion states provided by the autonomous driver unit, and so forth. In this manner, the safety integrity libraries of the drive API and/or the safety API enable the central control unit to monitor and react to faults in any of a range of edge devices implemented in a vehicle.

The hooks and services integrated by the central control unit via the safety integrity libraries are specific to the vehicle edge devices. For instance, if the autonomous driver unit includes a perception unit, such as Light Detection and Ranging (Lidar) processing unit, the safety integrity libraries are configured to include a perception group (e.g., a perception processing handler, a motion processing handler, and so forth) tailored for the autonomous driver unit, such that the ongoing health of the autonomous driver unit and its components (e.g., sensors and processors) are reported to the central control unit. The safety integrity libraries provided to edge devices via the drive and safety APIs of the central control unit thus enable the central control unit to take corrective action (e.g., issue fault mitigation commands) in response to detecting an edge device fault.

Corrective action, for instance, includes issuing an actuation command that remedies one or more faults associated with a vehicle control command received from a controlling unit, issuing an actuation command that resolves a difference between an expected function of a controlled device and data describing an actual state of the controlled device, cutting power to an edge device, stopping the vehicle (e.g., via controlled braking), causing the vehicle to perform a minimum risk maneuver, and so forth. In this manner, the higher integrity of the central control unit (e.g., the ASIL-D certification) is imparted on other edge devices of the vehicle, thereby uplifting an overall safety integrity level of the edge devices, despite one or more of the other edge devices not itself being certified at the higher safety integrity level.

In some aspects, the techniques described herein relate to a system including a central control unit configured to maintain a global safety state of a vehicle by providing a drive application programming interface (API) that enables a controlling unit to issue vehicle control commands for autonomously driving the vehicle, and providing a safety API that enables the central control unit to receive information describing a health status of the controlling unit of the vehicle, a communication link that couples the central control unit and the controlling unit using the drive API and the safety API, and the controlling unit configured to autonomously drive the vehicle by sending at least one vehicle control command to the central control unit for routing to a controlled unit of the vehicle.

In some aspects, the techniques described herein relate to a system, wherein the controlling unit is configured to autonomously drive the vehicle independent of one or more human inputs after initiating travel along a route.

In some aspects, the techniques described herein relate to a system, wherein the controlling unit is configured to autonomously drive the vehicle by defining a motion path for the vehicle and one or more vectors for moving the vehicle along the motion path.

In some aspects, the techniques described herein relate to a system, the central control unit further configured to identify a fault in the system based on data received from the controlling unit via one or more of the drive API or the safety API, wherein the at least one vehicle control command is included in the vehicle control commands routed to the controlled unit of the vehicle responsive to not identifying the fault in the system.

In some aspects, the techniques described herein relate to a system, the central control unit further configured to identify a fault in the system based on data received from the controlling unit via one or more of the drive API or the safety API, and issue a fault mitigation command to the controlling unit in response to identifying the fault in the system, the fault mitigation command causing the controlling unit to generate a corrected vehicle control command that remedies the fault.

In some aspects, the techniques described herein relate to a system, the central control unit further configured to cause the controlled unit to perform corrective action in response to identifying that the corrected vehicle control command fails to remedy the fault.

In some aspects, the techniques described herein relate to a system, wherein the corrective action includes causing the controlled unit to perform controlled braking.

In some aspects, the techniques described herein relate to a system, wherein the corrective action includes causing the controlled unit to perform a minimum risk maneuver that diverts a motion path of the vehicle from at least one object.

In some aspects, the techniques described herein relate to a system, wherein the corrective action includes the central control unit severing power from the controlled unit.

In some aspects, the techniques described herein relate to a system, wherein the corrective action includes activating a redundant instance of the controlled unit and causing the controlled unit to reboot while the redundant instance of the controlled unit executes the at least one vehicle control command.

In some aspects, the techniques described herein relate to a system, wherein the drive API and the safety API each include a library of hooks and services that maintain a health of the controlling unit at an ASIL-D integrity level.

In some aspects, the techniques described herein relate to a system, wherein the controlling unit is not certified at the ASIL-D integrity level.

In some aspects, the techniques described herein relate to a system, wherein the library of integrity hooks and services include instructions that communicate information describing the health of at least one component of the controlling unit at defined intervals during operation of the vehicle.

In some aspects, the techniques described herein relate to a method including receiving, by a central control unit of an autonomous vehicle, a vehicle control command from a controlling unit of the autonomous vehicle via a drive application programming interface (API) connecting the central control unit and the controlling unit, receiving, by the central control unit, controlling unit safety data from the controlling unit via a safety API connecting the central control unit and the controlling unit, identifying, by the central control unit, a failure associated with the controlling unit by processing the vehicle control command using a safety integrity library integrated into the drive API, or processing the controlling unit safety data using a safety integrity library integrated into the safety API, and causing, by the central control unit, performance of a corrective action in response to detecting the failure associated with the controlling unit.

In some aspects, the techniques described herein relate to a method, wherein causing performance of the corrective action includes transmitting an actuation command to at least one controlled unit of the autonomous vehicle that causes controlled braking of the autonomous vehicle.

In some aspects, the techniques described herein relate to a method, wherein causing performance of the corrective action includes transmitting a fault mitigation command to the controlling unit, the fault mitigation command causing the controlling unit to transmit a corrected vehicle control command to the central control unit within a threshold amount of time.

In some aspects, the techniques described herein relate to a method, wherein the drive API and the safety API each include a library of hooks and services that maintain a health of the controlling unit at an ASIL-D integrity level, wherein the central control unit is certified at the ASIL-D integrity level and the controlling unit is not certified at the ASIL-D integrity level.

In some aspects, the techniques described herein relate to a method, wherein causing performance of the corrective action includes causing at least one controlled unit of the autonomous vehicle to perform a minimum risk maneuver that maintains a safety envelope of the autonomous vehicle.

In some aspects, the techniques described herein relate to a method, wherein the central control unit is further configured to identify the failure associated with the controlling unit based on feedback data received from at least one monitor disposed within a controlled unit of the autonomous vehicle, wherein the failure is identified by comparing the feedback data to an expected response of the controlled unit from performing the vehicle control command.

In some aspects, the techniques described herein relate to a computer-readable storage medium storing instructions that are executed by at least one processor of a central control unit of an autonomous vehicle to receive a vehicle control command from a controlling unit of the autonomous vehicle via a drive application programming interface (API) connecting the central control unit and the controlling unit, receive controlling unit safety data from the controlling unit via a safety API connecting the central control unit and the controlling unit, identify a failure associated with the controlling unit based on at least one of processing the vehicle control command using a safety integrity library integrated into the drive API processing the controlling unit safety data using a safety integrity library integrated into the safety API, and perform a corrective action in response to detecting the failure associated with the controlling unit.

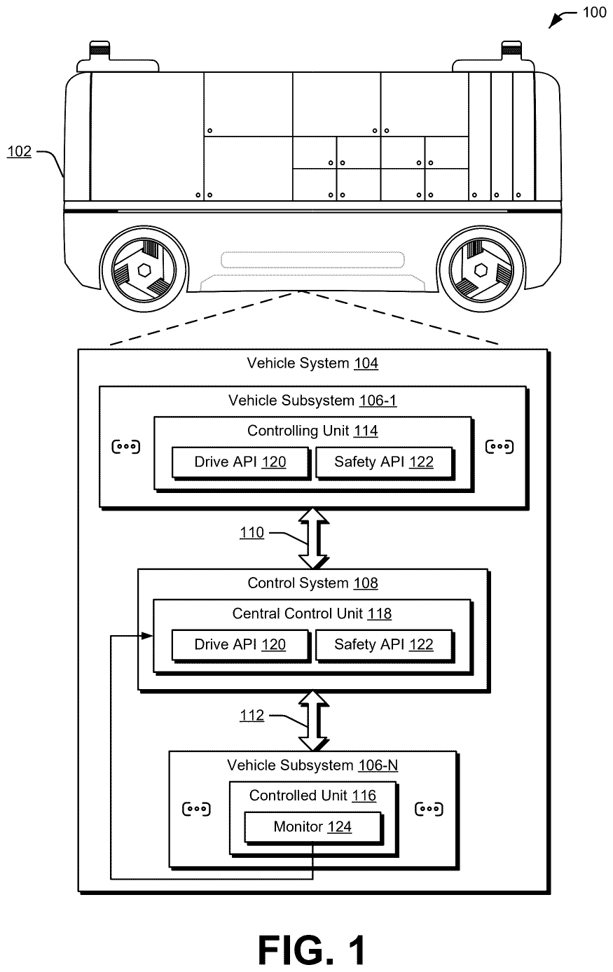

FIG. 1 illustrates an example environment 100 that includes a vehicle 102 having a vehicle system 104 configured to uplift a safety certification level of various units of the vehicle 102. The environment 100 is representative of a range of different environments in which the vehicle 102 operates, such as a roadway, a traffic scenario, an off-road area (e.g., a construction site, a mining operation, or a recreational area), in the air, on or in the water, on or in other substances (e.g., within fluids and/or cellular material), in space, and other public or private spaces, combinations thereof, and so forth. Although depicted in FIG. 1 as having an example physical configuration, the vehicle 102 is representative of any vehicle type, such as a ground vehicle (e.g., truck, car, van, tractor-trailer, tank, motorcycle, scooter, utility vehicle, bus, etc.), an air vehicle, a rail vehicle, a marine vehicle, a space vehicle, combinations thereof, and so forth. In some implementations, the vehicle 102 is configured as an unmanned vehicle (e.g., an autonomously controlled vehicle and/or a remotely controlled vehicle). Alternatively or additionally, the vehicle 102 is configured as a manned vehicle (e.g., a semi-autonomously controlled vehicle, a vehicle controlled by a human operator disposed on or in the vehicle, or the like).

The vehicle 102 includes a vehicle system 104. The vehicle system 104 includes multiple electronic systems configured to interface with electro-mechanical components of the vehicle 102 and implement processor-based vehicle functions and processor-driven operations, such as autonomously driving (e.g., maneuvering) the vehicle 102 in the environment 100. The vehicle system 104 additionally includes a vehicle network that operatively couples a vehicle control system to a plurality of vehicle subsystems. For instance, the vehicle system 104 is depicted as including a plurality of vehicle subsystems 106, which each represent an edge device of the vehicle 102 that is communicatively coupled (e.g., via the vehicle network) to a control system 108 of the vehicle 102. Specifically, the vehicle system 104 is depicted as including N different vehicle subsystems 106, where N represents any integer. In some implementations, the vehicle network includes dedicated connections between the control system 108 and individual ones of the vehicle subsystems 106. For instance, FIG. 1 depicts an example in which vehicle subsystem 106-1 is communicatively coupled with control system 108 via communication link 110 and vehicle subsystem 106-N is communicatively coupled with control system 108 via communication link 112.

Communication links of the vehicle network (e.g., communication link 110 and communication link 112) are implemented as wired and/or wireless connections for communicating data between and/or among various units of the vehicle system 104. For instance, different units of the vehicle system 104 connected by a communication link of the vehicle network are configured to exchange data (e.g., safety data, health data, operating data, feedback data, requests for data, commands, signals, and so forth) in a uniform manner. In implementations, data transmission by communication links of the vehicle network is end-to-end protected via authentication and encryption. In some implementations, the vehicle network includes redundant communication links between different units of the vehicle system 104, such as multiple instances of the communication link 110 coupling vehicle subsystem 106-1 and control system 108. In some implementations, one or more communication links of the vehicle network (e.g., communication link 110 and communication link 112) are configured as dual path communication links, such that each of two endpoints connected by a single communication link are able to simultaneously transmit data to, and receive data from, the other of the two endpoints.

Configuring communication links of the vehicle network as dual path connection links advantageously enables for more rapid communication (e.g., of safety data) relative to single path communication links. In implementations, communication links of the vehicle network include, but are not limited to, wired connections such as Ethernet connections or links, memory channels, buses (e.g., a data bus, a system or address bus, a controller area network or CAN bus), interconnects, through silicon vias, traces, pins and sockets, planes, optical connections, fiber optic connections, connections or links based on quantum entanglement, wireless connections combinations thereof, and so forth. Alternatively or additionally, communication links of the vehicle network include, but are not limed to, wireless connections such as Wi-Fi, Bluetooth, cellular networks, satellite networks, near field communications (NFC), infrared, light fidelity (Li-Fi), combinations thereof, and so forth.

Via their coupling by one or more communication links of the vehicle network, the control system 108 is configured to interface with, and manage operation of, each of the vehicle subsystems (e.g., vehicle subsystem 106-1 to vehicle subsystem 106-N). As described in further detail below, examples of vehicle subsystems 106 of the vehicle system 104 include a controlling unit 114 and a controlled unit 116. In an example context where the vehicle 102 is configured for autonomous driving, the controlling unit 114 is representative of one or more components that are configured to provide a motion path for guiding the vehicle 102 along one or more paths or vectors in the environment 100 (e.g., the controlling unit 114 is an autonomous driver of the vehicle 102). Continuing this example context, the controlled unit 116 represents one or more components that are configured to move the vehicle 102 along the motion path defined by the controlling unit 114 (e.g., the controlled unit 116 is a traction motor control, a steering motor control, a body control unit, etc.).

To centrally manage each of the vehicle subsystems (e.g., vehicle subsystem 106-1 to vehicle subsystem 106-N), the control system 108 includes a central control unit 118. The central control unit 118 represents one or more components of the vehicle system 104 that are certified with a high-integrity safety certification rating (e.g., the central control unit 118 is ASIL-D certified). In accordance with the techniques described herein, the central control unit 118 is configured to uplift a safety certification rating of one or more of the vehicle subsystems 106 by exposing at least one of a drive API 120 or a safety API 122 to a vehicle subsystem 106 via the communication link coupling the central control unit 118 to the vehicle subsystem 106.

The drive API 120 and the safety API 122 are each configured by the central control unit 118 as including an integrated safety integrity library that ensures secure and reliable communication between the central control unit 118 and a connected vehicle subsystem 106. The safety integrity library integrated into the drive API 120 and the safety API 122 acts as a middleware layer within the respective API by providing functions and protocols that enforce safety checks and error handling. Upon boot-up (e.g., during a power cycle of one or more of the control system 108 or a vehicle subsystem 106) the control system and a vehicle subsystem 106 connect via a communicative coupling (e.g., communication link 110 or communication link 112) using one or more of the drive API 120 or the safety API 122. The drive API 120 and the safety API 122 each transparently invoke the integrated safety integrity library to monitor data exchanges, validate inputs, manage responses, and so forth, between the control system 108 and a vehicle subsystem 106.

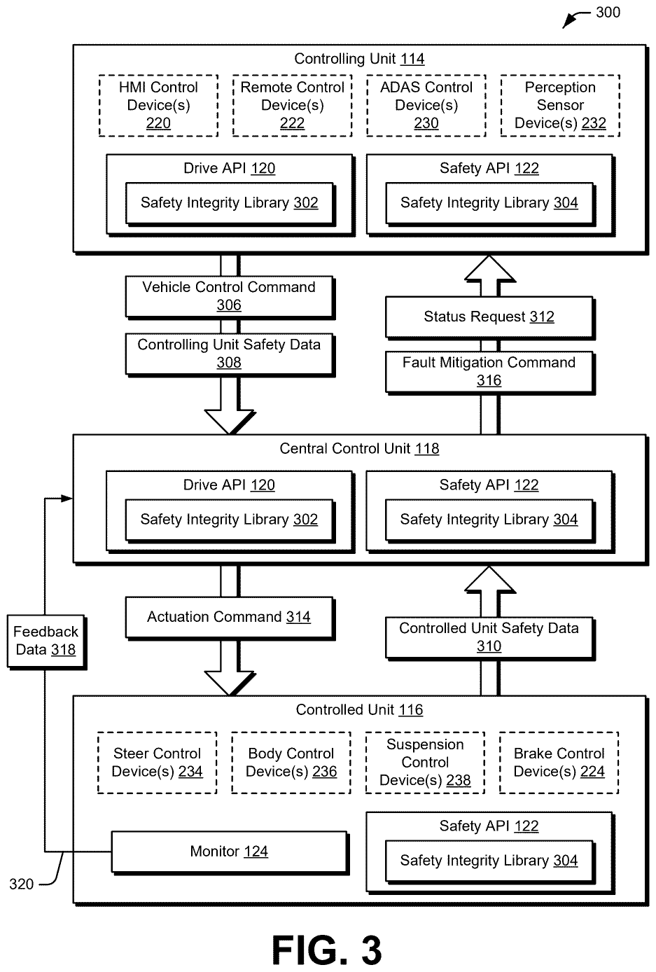

As described in further detail below with respect to FIG. 3, integrating the safety integrity library into the drive API 120 and the safety API 122 enables the central control unit 118 to continuously observe and react to any anomalies and faults in the vehicle system 104 by automatically triggering mitigation measures to maintain a safety envelope surrounding the vehicle 102 (e.g., physical separation of the vehicle 102 from other vehicles, objects, pedestrians, and hazards in the environment 100). By embedding safety features within the drive API 120 and the safety API 122, the central control unit 118 ensures that the vehicle subsystems 106 benefits from its high-integrity safety certification (e.g., ASIL-D certification) without requiring individual ones of the vehicle subsystems 106 to be certified at the same high-integrity safety certification, facilitating a seamless and secure interaction between units of the vehicle system 104.

The drive API 120 is representative of an interface (e.g., of the communication link 110) by which a vehicle subsystem 106 (e.g., controlling unit 114) and the central control unit 118 communicate information pertaining to the path and motion of the vehicle 102 (e.g., data describing functionality of physical and/or programmatic vehicle motion controls, such as steering wheel, accelerator, throttle, brake, gear shifter, and other components of the vehicle system 104 that influences a path, vector, or velocity of the vehicle 102). The safety API 122 is representative of an interface (e.g., of the communication link 112) by which a vehicle subsystem 106 (e.g., controlling unit 114) and the central control unit 118 communicate information pertaining to a health of the vehicle subsystem 106 and safety of the vehicle 102 resulting from inclusion of the vehicle subsystem 106 in the vehicle system 104. Generally, the safety API 122 enables the central control unit 118 to monitor a health status of a vehicle subsystem 106 based on current status information provided by the vehicle subsystem 106 and ensure that the path and motion of the vehicle (e.g., as controlled via data communicated through the drive API 120) is safe. In implementations, a determination of whether the path and motion of the vehicle is safe is assessed by the central control unit 118 relative to threshold safety values, such as a threshold degree of roll of the vehicle 102 relative to a stationary position, a threshold angular velocity imparted on a passenger or object disposed within the vehicle, a threshold amount of acceleration, a threshold distance between the vehicle 102 and another object, a threshold distance between a path of travel of the vehicle 102 and another vehicle's path of travel, and so forth).

Because the central control unit 118 includes a safety integrity library in each of the drive API 120 and the safety API 122, a vehicle component that uses one or more of the drive API 120 or the safety API 122 to communicate with the central control unit 118 is required to compile the safety integrity library as part of the respective API(s) to interface with the central control unit 118, and optionally one or more other units of the vehicle system 104. In this manner, the drive API 120 and the safety API 122 enable the vehicle system 104 to impart a higher-integrity safety level of the central control unit 118 on at least one other vehicle subsystem 106 of the vehicle system 104. Importantly, the safety integrity library integrated into the drive API 120 and the safety API 122 of the central control unit 118 is not simply a watchdog within the vehicle system 104 without an outcome. As described in further detail below, the drive API 120 and safety API 122, via their integrated safety integrity libraries, provide both monitoring and reaction functionality of the central control unit 118 certified at a high-integrity safety level. Such integration of the high-integrity safety functionalities provided by the central control unit 118, via the safety integrity libraries of the drive API 120 and the safety API 122, enable the central control unit 118 to identify failures from lower-integrity safety level components (e.g., the controlling unit 114 and the controlled unit 116) and react accordingly (e.g., cause controlled braking of the vehicle 102, cause the vehicle 102 to execute a minimum risk maneuver, or the like).

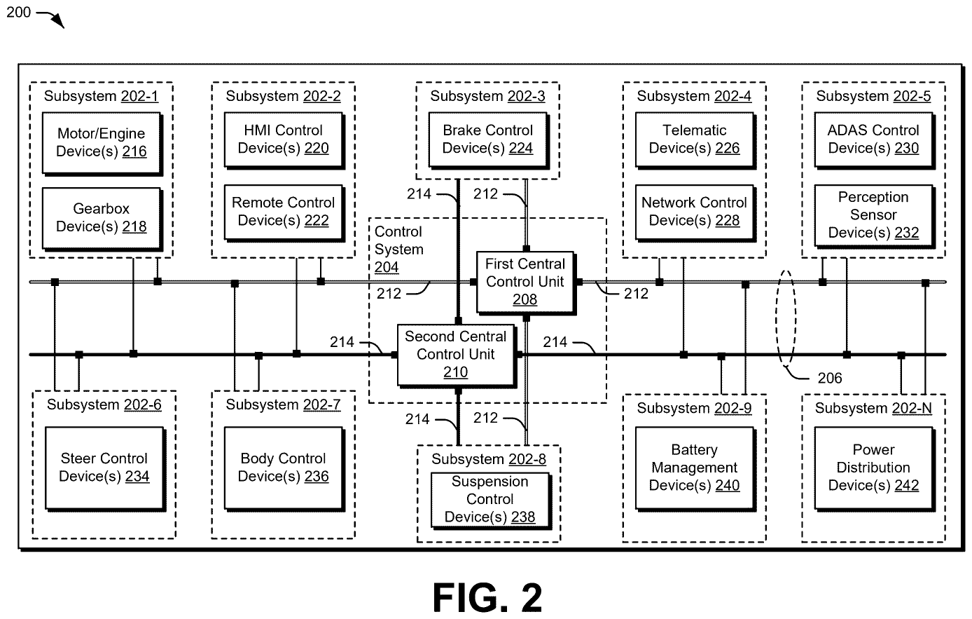

As mentioned above, and described in further detail below with respect to FIG. 2, vehicle subsystems 106 represent a range of different subsystems of the vehicle, broadly grouped into controlling units 114 and controlled units 116. Example vehicle subsystems 106 thus include, but are not limited to, a perception sensor subsystem (e.g., providing environmental condition information about the environment 100), a propulsion or motion subsystem (e.g., providing motion control), drive subsystem (e.g., providing autonomous or semi-autonomous motion control), transmission subsystem, powertrain subsystem, human-machine interface (HMI) subsystem (e.g., for receiving driver input, for receiving occupant input, for controlling in-vehicle infotainment), remote entry or remote start subsystem, braking subsystem (e.g., providing brake control), an electronic stability control (ESC) subsystem, and communication subsystem for handling on-board and/or offboard communications (e.g., data and telemetry, vehicle-to-vehicle, vehicle-to-everything, cellular, Bluetooth). Further examples include but are not limited to an ADAS, steering subsystem (e.g., providing steering control), active suspension subsystem, fuel management subsystem, battery management subsystem (e.g., providing traction energy, managing battery usage and charging control), power distribution subsystem, subsystem), alarm subsystem, payload subsystem, and extensible-assembly control subsystem (e.g., pod control, exterior tool control), and any other electronic-based subsystem of the vehicle 102 that is controllable by the control system 108.

In some implementations, the central control unit 118 is configured as at least one hardware processor of the control system 108 that is configured to control functionality of the vehicle subsystems 106 (e.g., instruct the controlling unit 114 to generate a motion path for the vehicle 102 and instruct the controlled unit 116 to move the vehicle 102 along the motion path generated by the controlling unit 114). In some implementations, the central control unit 118 is configured as multiple instances of redundant hardware, software, or combinations thereof. For instance, in some implementations the central control unit 118 is implemented in the vehicle system 104 as multiple (e.g., dual) central control units 118 that each represent identical processors or different hardware configurations that are configured to provide redundant functionality for one another. In this manner, failure of one instance of the central control unit 118 does not preclude ongoing functionality of the control system 108, as another instance of the central control unit 118 is configured to control the vehicle subsystems 106 and ensure safety of the vehicle 102.

In implementations, the central control unit 118 is configured as one or more processors that include electronic circuits configured to process instructions for executing control routines on the vehicle 102. Execution of control routines via one or more processors of the central control unit 118 enables the control system 108 to manage functionality of (e.g., data generated by, outputs performed by, etc.) different ones of the vehicle subsystems 106 in a manner that ensures a safety envelope for the vehicle 102. In implementations, individual ones of the vehicle subsystem 106 include one or more processors configured as electronic circuits for performing respective functionality of the vehicle subsystem 106, as instructed by the central control unit 118.

Example configurations of the hardware processors of the control system 108 (e.g., the central control unit 118) and the vehicle subsystems 106 include, but are not limited to, a central processing unit (CPU), a graphics processing unit (GPU), a field programmable gate array (FPGA), an accelerator, an accelerated processing unit (APU), and a system on chip (SoC), a microcontroller, an electronic control unit (ECU), a digital signal processor (DSP), an infrastructure processing unit (IPU), combinations thereof, and so forth. In some implementations, hardware processors of the control system 108 and/or the vehicle subsystem 106 are configured as a single processor or a single processor core. Alternatively or additionally, hardware processors of the control system 108 and/or the vehicle subsystem 106 are configured as multiple processors or multiple cores of a single processor working together in combination.

In implementations, at least one of the control system 108 or the vehicle subsystems 106 include a memory or a computer-readable storage medium that stores instructions for execution by the one or more processors (e.g., of the corresponding at least one of the control system 108 or the vehicle subsystems 106) to perform respective functionalities of the at least one of the control system 108 or the vehicle subsystems 106. For instance, the control system 108 and each vehicle subsystem 106 include a memory circuit, which stores instructions and data for deterministically executing one or more functions (e.g., software, firmware, or combinations thereof). In implementations, the memory circuit is configured as semiconductor memory where data is stored within memory cells on one or more integrated circuits. Alternatively or additionally, the memory circuit is representative of data stored on a disk, a storage array, non-transitory computer-readable storage medium, combinations thereof, and so forth.

In some implementations, the memory circuit of the control system 108 and/or the vehicle subsystem 106 is configured as volatile memory, examples of which include random-access memory (RAM), dynamic random-access memory (DRAM), synchronous dynamic random-access memory (SDRAM), static random-access memory (SRAM), memristors, and so forth. Alternatively or additionally, the memory circuit of the control system 108 and/or the vehicle subsystem 106 is configured as non-volatile memory, examples of which include flash memory, read-only memory (ROM), programmable read-only memory (PROM), erasable programmable read-only memory (EPROM), electronically erasable programmable read-only memory (EEPROM), and non-volatile random-access memory (NVRAM), such as phase-change memory (PCM) and magneto resistive random-access memory (MRAM). Further examples of memory configurations include low-power double data rate (LPDDR), also known as LPDDR SDRAM. Thus, the memory configuration supported by each of the control system 108 and/or the vehicle subsystem 106 is configurable in a variety of manners in accordance with the techniques described herein.

Due to conditions of the environment 100 (e.g., road conditions, weather, other vehicles, etc.), general wear and tear of the vehicle 102, component part failures, and so forth, individual ones of the vehicle subsystems 106 are susceptible to failures (e.g., faults, errors, inoperability, loss of power, etc.). By interfacing with one or more of the vehicle subsystems 106, the central control unit 118 is configured to continuously monitor a health of the one or more vehicle subsystems 106 during operation of the vehicle system 104 and react in response to detecting a vehicle subsystem 106 failure. As described in further detail below, the safety integrity libraries of the drive API 120 and the safety API 122 include hooks and services that cause a vehicle subsystem 106 connected to the central control unit 118 to constantly report data describing a current status and health of the vehicle subsystem 106 to the central control unit 118.

In some implementations, individual ones of the vehicle subsystems 106 include local functionality (e.g., functionality of the vehicle subsystem 106 independent of another component of the vehicle system 104) to perform fault observation, detection, and reaction within its local domain of control and safety. However, due to having a lower-integrity safety certification than the central control unit 118, such local functionality of a vehicle subsystem 106 to monitor and react to its own faults does not provide the same safety integrity as achieved by interfacing with the central control unit 118 via the drive API 120 and/or the safety API 122. For instance, in an example scenario where a vehicle subsystem 106 experiences complete failure (e.g., loss of power, is physically separated from the vehicle system 104, etc.), local functionality of the vehicle subsystem 106 is unable to react to its own failure.

Conversely, the techniques described herein cause reporting of the vehicle subsystem 106 failure to the central control unit 118, which enables the central control unit 118 to react on behalf of the failed vehicle subsystem 106, ensuring safety of the vehicle 102. In doing so, the safety certification level of a vehicle subsystem 106 is uplifted to the high-integrity level of the central control unit 118 (e.g., ASIL-D) by causing the vehicle subsystem 106 to be monitored, and failures reacted to, using the safety measures of the central control unit 118. In implementations, the high-integrity safety level certification of the central control unit 118 ensures that a safety envelope of the vehicle 102 is maintained (e.g., that a threshold distance exists between a location in physical space occupied by the vehicle 102 and one or more other objects in the environment 100). Advantageously, the central control unit 118 maintains a safety envelope of the vehicle 102 independent of (e.g., without) reliance on human intervention (e.g., either intervention of a driver or human passenger disposed within the vehicle 102 or a human remotely controlling the vehicle 102).

To do so, the central control unit 118 is configured to react (e.g., via data received from one or more vehicle subsystems 106 via the drive API 120 and safety API 122) with a predetermined (e.g., programmatically deterministic) response by executing code that has been audited for compliance with a high-integrity safety level (e.g., ASIL-D certification). In an example implementation, the central control unit 118 is configured to respond to a vehicle subsystem 106 fault reported via the drive API 120 or the safety API 122 by issuing a fault mitigation command to the vehicle subsystem 106 at which a fault was detected, an actuation command to a different vehicle subsystem 106, or combinations thereof, to mitigate the fault.

As a specific example, in a scenario where a fault is detected at a vehicle subsystem 106 configured as a steering motor control unit, the central control unit 118 transmits a fault mitigation command to the steering motor control unit to remedy the fault (e.g., if the steering motor control unit does not turn the vehicle 102 along an intended path, the central control unit 118 instructs the steering motor control unit to return the vehicle 102 to the intended path). Continuing this example, if the central control unit 118 determines that the fault mitigation command was unsuccessful (e.g., that the steering motor control unit did not return the vehicle 102 to the intended path within a threshold amount of time), the central control unit 118 issues an actuation command to another vehicle subsystem 106 (e.g., actuates a redundant steering motor control unit to maneuver the vehicle 102 to return to the intended path).

Further to this example, in an instance where the fault mitigation command to the faulty vehicle subsystem 106 and optional actuation command to at least one other vehicle subsystem 106 fail to remedy the detected fault, the central control unit 118 instructs functioning vehicle subsystems 106 to perform controlled braking or a minimum risk maneuver. For instance, the central control unit 118 causes the vehicle 102 to come to a controlled stop out of a path of traffic, humans, animals, or other objects in the environment 100, thereby ensuring a safety envelope of the vehicle 102 and protecting its occupants.

In some implementations, the central control unit 118 is configured to observe and react to a current state of at least one vehicle subsystem 106 that is not connected to the control system 108 via one or more of the drive API 120 or the safety API 122. For instance, in the illustrated example of FIG. 1, the controlled unit 116 represents a vehicle subsystem 106 that is part of the vehicle system 104 but not connected to the control system 108 via the drive API 120 or the safety API 122. In order to uplift a safety integrity level of the controlled unit 116, the vehicle system 104 implements a monitor 124 that reports status information of the controlled unit 116 to the central control unit 118. In this manner, the central control unit 118 is able to reliably observe a current status of the controlled unit 116 and react accordingly, without having to trust status information reported by the controlled unit 116, which cannot be trusted above a safety certification level of the controlled unit 116 itself. This unreliability of status information reported by the controlled unit 116, relative to the reliability of status information reported by the controlling unit 114, is due to the absence of the drive API 120 or the safety API 122 compiled into the controlled unit 116.

For a description of specific vehicle subsystems monitored, and reacted to, by the central control unit 118, consider FIG. 2.

FIG. 2 is a block diagram of a non-limiting example of a vehicle system 200 that implements a control system to uplift a safety integrity level of vehicle subsystems. The vehicle system 200 is described in the context of the environment 100 of FIG. 1, including with reference to similarly labeled elements. For example, the vehicle system 200 is a more detailed version of the vehicle system 104 installed in the vehicle 102. The vehicle system 200 includes a plurality of subsystems 202 (labeled individually as subsystem 202-1 through subsystem 202-N, where N is any integer) managed by a control system 204 to implement various vehicle functions. In this manner, each of the subsystems 202 are representative of a corresponding vehicle subsystem 106. The vehicle subsystems 202 are distributed on the vehicle 102 and include one or more edge devices. In at least one example, the vehicle system 200 includes additional or fewer subsystems 202 than those depicted in FIG. 2.

The control system 204 is configured as a centralized controller that enables information to transfer between the subsystems 202 over a network 206 (e.g., a vehicle network). By exchanging information with the subsystems 202, the control system 204 causes the subsystems 202 to execute subsystem functions that enable driving. In this manner, the control system 204 represents an instance of the control system 108 and the network 206 represents a vehicle network including the communication link 110 and the communication link 112, at least one of which supports communication via the drive API 120 and/or the safety API 122. For instance, the control system 204 receives signals output on the network 206 from one of the subsystems 202, and based on information inferred from the signals, the control system 204 outputs additional signals on the network 206 to cause a particular behavior of at least one of the other subsystems 202.

The control system 204 includes at least two central control units 208 and 210. Each of the at least two central control units 208 and 210 are representative of an instance of the central control unit 118. In this manner, the control system 204 represents an example implementation of the control system 108 having redundant functionality of the central control unit 118. The control system 204 and the central control units 208, 210 are centrally located on the vehicle 102 (e.g., relative the edge devices and the vehicle subsystems 202), in at least one example. In at least one other example, the control system 204 is positioned on the vehicle 102 closer to one or more edge devices and the vehicle subsystems 202 than others of the edge devices and vehicle subsystems 202. In other implementations, the control system 204 includes a single central control unit or other processing device (e.g., a single instance of the central control unit 118).

The control system 204 includes a first central control unit 208 and a second central control unit 210. The first central control unit 208 and the second central control unit 210 represent separate processors, processor cores, control units, microcontrollers, systems on chip, or other processor technology. Each central control unit 208, 210 is configured to execute instructions either as software or firmware to implement functionality of the control system 204. Although not shown, in some examples, the control system 204 includes a non-transitory computer-readable storage medium (e.g., data store, cache, static memory, dynamic memory, flash memory, disk storage) that maintains the instructions and data for implementing the instructions executed by each of the first central control unit 208 and the second central control unit 210. For example, the first central control unit 208 and the second central control unit 210 include respective data stores that contain the instructions retrieved from the data stores and executed during the operation of vehicle 102.

As noted above with respect to FIG. 1, examples of the processors of the central control units 208, 210 and/or the edge devices include but are not limited to a central processing unit (CPU), graphics processing unit (GPU), field programmable gate array (FPGA), accelerator, accelerated processing unit (APU), and system on chip (SoC), microcontroller, electronic control unit (ECU), and digital signal processor (DSP), to name a few. In one or more variations, the processors of the central control units 208, 210 and/or the edge devices include multiple co-processors or multiple cores (e.g., a multi-core processor). In one or more other variations, the processors of the central control units 208, 210 and/or the edge devices include only one core (e.g., a single processor core).

In one or more implementations, the central control units 208, 210 include the same hardware technology. For example, the first central control unit 208 and the second central control unit 210 have identical processor technology. In one or more other implementations, the central control units 208, 210 include different hardware configurations that implement the same functionality. For example, a processor of the first central control unit 208 and the second central control unit 210 have different processor technology configured to execute identical control routines.

In another implementation, the control system 204 is distributed throughout the vehicle system 200 in two or more locations. In such a distributed implementation, the first central control unit 208 is included in a first part of the control system 204 arranged at one part of the vehicle 102 (e.g., a front portion) and the second central control unit 210 is included in a second part of the control system 204 positioned at another part of the vehicle 102 (e.g., a rear portion). In other distributed implementations, each part of the control system 204 includes one or more multiple instances of the first central control unit 208 and/or the second central control unit 210.

In one or more examples, the first central control unit 208 and the second central control unit 210 are functionally redundant. For example, the processors of each of the first central control unit 208 and the second central control unit 210 are operable to concurrently receive the same set of inputs from the subsystems 202 and concurrently send the same set of outputs to the subsystems 202 (e.g., via the drive API 120 and/or the safety API 122). Similarly, the processors of each of the first central control unit 208 and the second central control unit 210 are operable to concurrently receive the same set of inputs from the subsystems 202 and concurrently send the same set of outputs to the subsystems 202 regardless of whether that processor is the healthiest.

The subsystems 202 of the vehicle system 200 rely on equivalent control operations of either the first central control unit 208 or the second central control unit 210 (e.g., one at a time) to actively cause vehicle operations or vehicle functions to be performed by the subsystems 202. For example, in some implementations, while the first central control unit 208 is orchestrating operations of the subsystems 202, the second central control unit 210 is maintained in a ready, standby state. If the first central control unit 208 fails, then the control system 204 activates the second central control unit 210 to take over and manage the subsystems 202 where the first central control unit 208 left off.

When the second central control unit 210 takes over, the vehicle 102 may be forced to operate in a safe state, which can include performing a minimum risk maneuver (e.g., maneuvering the vehicle 102 away from other vehicles, objects, pedestrians, or travel paths thereof), performing braking to come to a controlled stop, or combinations thereof. This way, the functional redundancy implemented by the first central control unit 208 and the second central control unit 210 helps the control system 204 satisfy the ASIL-D requirements for reliability and safety. In such implementations, the first central control unit 208 and the second central control unit 210 may be located at different locations within the vehicle (e.g., to safeguard against concurrent failure resulting from environmental conditions that compromise a physical location at which one of the first central control unit 208 or the second central control unit 210 is disposed).

The network 206 represents any suitable vehicle network technology, including wired and wireless signal propagation mediums. The network 206 enables real-time data exchange, safety enhancements, and efficient traffic management among the components of the vehicle system 200. Network 206 can include various switches, routers, transceivers, controllers, chokes, filters, terminations, and other networking equipment beyond transmission lines, cables, wires, buses, and other signal-routing technologies. In an aspect, the network 206 adheres to an in-vehicle networking protocol. For example, the network 206 represents a combination of one or more of a controller area network (CAN), automotive ethernet network (AEN), serializer/deserializer (SerDes) network, local interconnect network (LIN), or FlexRay network (FRN).

In at least one example, to implement the redundancy of the control system 204, the network 206 includes dual physical network paths or network channels. In at least one example, the first central control unit 208 and the second central control unit 210 are operable to concurrently exchange the same set of inputs and outputs with the subsystems 202 over different respective channels (e.g., logical or physical channels) of the network 206 that link the subsystems 202 to that central control unit (e.g., processor). A network channel 212, or network path, communicatively couples subsystems 202 to the first central control unit 208. A separate network channel 214 or network path communicatively links subsystems 202 to the second central control unit 210. For example, the network channel 212 is utilized by the first central control unit 208 to exchange data over the network 206, and the network channel 214 is utilized by the second central control unit 210 to exchange data over the network 206. In at least one implementation, if a failure at the first central control unit 208 is at least partially caused by a fault in the network channel 212, the second central control unit 210 is unaffected by the network fault and operable to communicate with the subsystems 202 using the network channel 214. The functional redundancy implemented by network channel 212 and network channel 214 further helps control system 204 to satisfy the ASIL-D requirements for reliability and safety.

In at least one other example, to implement the redundancy of the control system 204, the network 206 includes dual logical network paths or channels. In some implementations, the network channel 212 and the network channel 214 are configured as separate logical paths through the network 206 that communicatively link each subsystem 202 to the first central control unit 208 and the second central control unit 210 using the same physical wires. In at least one example, the first central control unit 208 and the second central control unit 210 are operable to interleave the same set of inputs and outputs concurrently exchanged with the subsystems 202 over the same set of channels (e.g., logical or physical channels) of the network 206 that link the subsystems 202 to that central control unit (e.g., processor).

For example, communications to and from the first central control unit 208 and the second central control unit 210 are interleaved on a single set of wires that make up the network 206. If a failure at the second central control unit 210 and/or the network channel 214 occurs, communications from the first central control unit 208 can reach the subsystems 202 using the network channel 212. The functional redundancy implemented by interleaving network channel 212 and network channel 214 further helps the control system 204 to satisfy the ASIL-D requirements for reliability and safety.

Although not depicted in the illustrated example of FIG. 2, communication links of the network 206 (e.g., network channel 212 and network channel 214) enable communications between the control system 204 and the subsystems 202 by exposing at least one of the drive API 120 or the safety API 122. Within the drive API 120 and the safety API 122, a comprehensive safety integrity library integrates various hooks and services to ensure the vehicle 102 operates safely and reliably under all conditions. The respective safety integrity libraries of the drive API 120 and the safety API 122 include health hooks and services, incorporating health check endpoints and heartbeat mechanisms, defined by the central control unit 118 for the respective subsystems 202, that constantly monitor the subsystems 202 vital signs.

By integrating a safety integrity library into a drive API 120 and/or a safety API 122 included in each communication link of the network 206, the control system 204 ensures the vehicle system 200, and each subsystem 202 included therein, operates safely, reliably, and efficiently, adapting to the complex demands of real-world driving while maintaining the highest standards of safety and integrity (e.g., ASIL-D). Functionality of the safety integrity libraries of the drive API 120 and the safety API 122 are described in further detail below with respect to FIG. 3.

In a similar manner, the central control unit 118 (e.g., the first central control unit 208 and the second central control unit 210) are configured to regularly query each subsystem 202 for status updates, ensuring that all subsystem functionality (e.g., sensor readings, computational processes, and so forth) are operating without failure. In response to any anomalies detected via the observation and reporting hooks and services of the drive API 120 and the safety API 122, the respective safety integrity libraries include reaction elements that cause the central control unit 118 to take corrective action (e.g., issue a fault mitigation command to a faulty subsystem 202, issue an actuation command to another subsystem 202, or combinations thereof).

Each subsystem 202 includes one or more edge devices operatively coupled to the network 206 to provide information to the control system 204 and receive commands from the control system 204 to implement various vehicle functions. For example, each subsystem 202 can include one or more actuators, microcontrollers, machines, or other equipment to perform specific vehicle tasks at the control of the edge devices that are contained within subsystem 202.

A subsystem 202-1 is a propulsion or drive subsystem. Motor/engine devices 216 of the subsystem 202-1 represent edge devices managed by the control system 204 to command vehicle propulsion units (e.g., an engine, a motor) to execute driving functions of the vehicle 102 (e.g., forward motion, reverse motion, acceleration, deceleration). In one or more examples, the motor/engine devices 216 manages operations of an engine of vehicle 102, including fuel injection, ignition timing, emissions control, and engine health monitoring. In at least one aspect (e.g., for electric vehicles), the motor/engine devices 216 control inverters and motors that convert electric energy into mechanical energy for applying torque to wheels.

In addition, the subsystem 202-1 includes gearbox devices 218. Also referred to as a powertrain control module (PCM) and/or a transmission control module (TCM), transmission and gearbox functions are overseen by the gearbox devices 218 to implement an automatic transmission, optimize gear changes (e.g., gear shifts), and control torque delivered to the wheels of the vehicle 102. A vehicle may include one or more instances of subsystem 202-1 (e.g., one subsystem 202-1 for each axle).

A subsystem 202-2 is a human-machine interface (HMI) subsystem. The subsystem 202-2 includes one or more HMI control devices 220 that implement a vehicle user interface. The vehicle user interface enables interaction between occupants (e.g., driver, passenger, user) of the vehicle 102 and the vehicle system 200, which enables human intervention and control of vehicle functions and driving. For example, the HMI control devices 220 control vehicle displays, vehicle dash clusters, head-up display units, haptic feedback, audible feedback, and other visual driving aids interpreted by the occupants to help with driving or ensuring safe vehicle operations. In one or more implementations, the HMI control devices 220 provide a human interface to control climate controls (e.g., heating, cooling), cabin features (e.g., infotainment, interior lighting), and other vehicle body features (e.g., windshield wipers, transmission settings, suspension settings, drive mode selection, power seating, power mirrors, power door locks).

The subsystem 202-2 also includes one or more remote control devices 222 that allow human or machine inputs to control the vehicle 102 from outside the cabin. For example, in an autonomous or semi-autonomous vehicle context, the remote control devices 222 receive commands over a communication link with a base station (e.g., a mobile phone, a key fob, a remote computing system) to allow a human or machine operator to control the vehicle 102 as if the driving commands are provided directly to the HMI control devices 220. In hot or cold weather, the remote control devices 222 activate remote starting functions to pre-cool or pre-heat the cabin. In at least one aspect, the remote control devices 222 allow door locks to be unlocked or locked and doors, tailgates, or trunks to be remotely opened or closed.

A subsystem 202-3 represents a braking subsystem of the vehicle system 200. For example, one or more brake control devices 224 are operable to manage anti-lock braking systems (ABS), electronic stability controls (ESC), and otherwise convert driver inputs at the HMI control devices 220 to control vehicle brakes (e.g., for stopping, for decelerating). In some examples, the brake control devices 224 represent a braking control module (BCM).

A subsystem 202-4 is an onboard-vehicle communication subsystem, which manages telematics and communications that occur within the vehicle 102 and with other devices located outside the vehicle 102. For example, the subsystem 202-4 interfaces with the various edge devices coupled to the network 206 to ensure a healthy exchange of data free of errors or faults. In addition, the subsystem 202-4 interfaces with other vehicles, mobile devices, infrastructure, and remote computing systems to implement various vehicle functions. One or more network control devices 228 of subsystem 202-4 monitor network health of network 206 and facilitate communication protocols implemented therein. The network control devices 228 are configured to diagnose problems with the network 206 to reroute signals and prevent data loss.

One or more telematic devices 226 of the subsystem 202-4 handle offboard or external communications of the vehicle 102. This includes implementing vehicle-to-vehicle (V2V) and vehicle-to-everything (V2X) communications that enable the vehicle 102 to communicate with other intelligent vehicles and systems in an operating environment (e.g., on or near a roadway). The telematic devices 226 interface with over-the-air (OTA) update services to update the software on the vehicle 102. In addition, the telematic devices 226 interface with a positioning system to assist with navigation functions. Other features implemented by the telematic devices 226 include remote diagnostics and interfacing with emergency response services (e.g., to alert emergency responders in the event of an accident automatically).

A subsystem 202-5 is an advanced driving and safety (ADAS) subsystem of the vehicle system 200. The subsystem 202-5 has two main functions, including implementing an ADAS and a perception sensor system. For example, one or more ADAS control devices 230 implement ADAS functionality that includes autonomous or semi-autonomous control, adaptive cruise control, emergency braking, lane centering, and other ADAS functions. One or more perception sensor devices 232 support the ADAS control devices 230 by providing information about the driving environment to ensure safe driving. For example, a radar, a camera, a lidar, an ultrasonic sensor, a global position system (GPS) sensor, an inertial measurement unit (IMU), and other sensor technology are deployed by the perception sensor devices 232 to collect sensor data about a vehicle environment. Sensor fusion techniques, object detection, lane centering, path trajectory planning, and other perception sensor functions are executed by the perception sensor devices 232 to enable ADAS control devices 230 to perform ADAS functions.

A subsystem 202-6 is a steering subsystem that controls elements of the vehicle to steer the wheels. One or more steer control devices 234 integrate with an electric power steering system of the vehicle 102 to control the direction of the vehicle wheels. The steer control devices 234 receive inputs from the HMI control devices 220 and/or the control system 204, which are translated into appropriate steering commands for controlling steering actuators that change the wheels'direction for steering and performing evasive maneuvers.

A subsystem 202-7 represents a body control subsystem of the vehicle 102. Included in the subsystem 202-7 are one or more body control devices 236, which oversee functions related to vehicle body controls. For example, window actuators, door locks and latches, interior and exterior lighting, tailgate and trunk latches, and the like are controlled by the body control devices 236 at the command of the control system 204 and/or one or more of the other subsystems 202 (e.g., the HMI control devices 220).

A subsystem 202-8 is an active suspension control subsystem. One or more suspension control devices 238 implement functions of a suspension control module (SCM) to regulate suspension components to adjust the ride level of the vehicle 102. For example, suspension control devices 238 configure a vehicle suspension to be stiffer on paved surfaces for improved driving performance and maneuverability. In an offroad setting, the suspension control devices 238 enable a softer suspension setting to provide a smoother ride.

A subsystem 202-9 represents a battery management subsystem of the vehicle 102. One or more battery management devices 240 monitor the performance of a battery pack (also referred to as a traction battery) to ensure appropriate charging and discharging rates to promote longevity and overall battery health. The battery management devices 240 control charging operations of onboard vehicle batteries as well as controlling battery usage (e.g., to control a rate of discharge). The battery management devices 240 monitor the health of vehicle batteries to alert the control system 204 when a malfunction is imminent or occurs.

Finally, a subsystem 202-N is depicted in FIG. 2, representing a power distribution system. One or more power distribution devices 242 of the subsystem 202-N manage the distribution of electrical power from energy sources on the vehicle 102 to the vehicle system 200. For example, the power distribution devices 242 control power switches, inverters, converters, and other electrical distribution components to ensure the subsystems 202 receive an appropriate level of current and voltage for implementing vehicle functions. The power distribution devices 242 can include fault protection circuits and breakers to interrupt power to a faulty subsystem and maintain safe electrical conditions while the vehicle 102 remains active. The power distribution devices 242 interface with the motor/engine devices 216 and the battery management devices 240 to manage safe electrical conditions throughout the vehicle system 200. Having considered example subsystems of a vehicle system 104, consider now a further description of the central control unit 118 uplifting a safety level of the vehicle 102 by interfacing with vehicle subsystems using the drive API 120 and the safety API 122.

FIG. 3 depicts an example environment 300 that includes a block diagram of the central control unit 118 monitoring and reacting to operation of vehicle subsystems (e.g., controlling unit 114 and controlled unit 116) in a manner that enforces a high-integrity safety certification level of the central control unit 118 on the vehicle subsystems. The illustrated environment 300 includes the controlling unit 114, which is representative of an instance of the HMI control devices 220, the remote control devices 222, the ADAS control devices 230, the perception sensor devices 232, or another unit of the vehicle system 104 configured to provide outputs that control a path, vector, velocity, or other motion of the vehicle 102. The illustrated environment 300 further includes the controlled unit 116, which is representative of an instance of the one or more steer control devices 234, the one or more body control devices 236, the suspension control devices 238, the one or more brake control devices 224, or another unit of the vehicle system 104 configured to operate the vehicle 102 in the environment 100 (e.g., by executing one or more commands issued by the central control unit 118 via the controlling unit 114).

The central control unit 118 is configured to communicate with vehicle subsystems (e.g., controlling unit 114 and controlled unit 116) by exposing at least one of the drive API 120 or the safety API 122 on a communication path (e.g., communication link 110 or communication link 112 of the network 206) linking the central control unit 118 and the vehicle subsystem. For instance, in the illustrated example of FIG. 3, because the controlling unit 114 represents a vehicle subsystem configured to provide outputs that define a path, vector, velocity, or other motion of the vehicle 102, the central control unit 118 interfaces with the controlling unit 114 using both the drive API 120 and the safety API 122. Alternatively, in some implementations that central control unit 118 interfaces with a vehicle subsystem using a single API (e.g., the central control unit 118 interfaces with the controlled unit 116 using the safety API 122).

The drive API 120 and the safety API 122 each include an integrated safety integrity library, which is compiled by the central control unit 118 and each vehicle subsystem that interfaces with the central control unit 118 using the drive API 120 or the safety API 122. For instance, the drive API 120 is depicted as including safety integrity library 302 and safety API 122 is depicted as including safety integrity library 304. The drive API 120 and the safety API 122 are representative of communication interfaces supported by communication links of the network 206 (e.g., communication link 110, communication link 112, network channel 212, network channel 214, and so forth). The safety integrity library 302 and the safety integrity library 304 each represent a comprehensive library of hooks and services to ensure the vehicle 102 operates safely and reliably under all conditions (e.g., at an ASIL-D safety level at which the central control unit 118 is certified). For instance, each of the safety integrity library 302 and the safety integrity library 304 include health hooks and services, incorporating health check endpoints and heartbeat mechanisms, defined by the central control unit 118 for the respective subsystems 202, that constantly monitor subsystem vital signs (e.g., vital signs of the controlling unit 114 and the controlled unit 116).

In a similar manner, by compiling the safety integrity library 302 and the safety integrity library 304 at boot time, the central control unit 118 (e.g., the first central control unit 208 and the second central control unit 210) is configured to regularly query each connected vehicle subsystem for status updates, ensuring that all subsystem functionality (e.g., sensor readings, computational processes, and so forth) are operating without failure. In response to any anomalies detected via the observation and reporting hooks and services of the safety integrity library 302 or the safety integrity library 304, the respective safety integrity libraries include reaction elements that cause the central control unit 118 to take corrective action (e.g., issue a fault mitigation command to the controlling unit 114, issue an actuation command to the controlled unit 116, or combinations thereof).

The safety integrity library 302 and the safety integrity library 304 each further include integrity hooks and services (e.g., data validation hooks that scrutinize every piece of incoming data against predefined schemas known to the central control unit 118), ensuring accuracy and consistency before data is processed by the central control unit 118. Transaction integrity checks of the safety integrity library 302 and the safety integrity library 304 ensure that critical operations of a vehicle subsystem are either fully completed or appropriately rolled back in case of errors, thus maintaining data consistency. In some implementations, safety integrity library 302 and the safety integrity library 304 cause the central control unit 118 to record audit trails for each vehicle subsystem, which describe each action performed by the subsystem (e.g., controlling unit 114 or controlled unit 116) and thus provide a transparent history that is essential for compliance (e.g., ASIL-D compliance) and troubleshooting.

To account for the dynamic environment of autonomous driving, the safety integrity library 302 and the safety integrity library 304 include time-sensitive services to ensure that sensor data and control commands are handled instantly, without delays that could compromise safety. Timeout management mechanisms of the safety integrity library 302 and the safety integrity library 304 compiled into the central control unit 118 and its connected vehicle subsystems prevent operations from hanging indefinitely. In some implementations, the safety integrity libraries of the drive API 120 and the safety API 122 include priority scheduling parameters to ensure that high-priority tasks (e.g., obstacle detection and reaction), are executed without delay.

To uplift one or more subsystems 202 with the high-integrity safety certification of the central control unit 118 (e.g., the controlling unit 114 and the controlled unit 116), the safety integrity library 302 and the safety integrity library 304 further include boot integrity services, which safeguard the vehicle system 104 from the moment it powers on. Secure boot mechanisms provided by the drive API 120 and the safety API 122 ensure that only trusted software is loaded (e.g., by a vehicle subsystem as well as by the central control unit 118), while boot attestation verifies that the boot process adheres to known good states, preventing unauthorized tampering. Firmware integrity checks of the safety integrity library 302 and the safety integrity library 304 validate firmware (e.g., of the controlling unit 114, the controlled unit 116, and the central control unit 118) before it runs, ensuring that software is secure and uncorrupted throughout the vehicle 102.

To maintain continuous operation, the safety integrity library 302 and the safety integrity library 304 each further include watchdogs (e.g., implemented as both hardware and software timers). Each watchdog included in a safety integrity library of the drive API 120 or the safety API 122 is further coupled to trigger a reaction by the central control unit 118 in response to detecting a vehicle subsystem failure (e.g., a failure of the controlling unit 114 or the controlled unit 116). For instance, hardware watchdogs are configured to cause the central control unit 118 to reset a vehicle subsystem if the central control unit 118 does not receive periodic signals from the vehicle subsystem. Software watchdogs monitor the health of critical processes, restarting them (e.g., individual processes executed by a vehicle subsystem or an entirety of the vehicle subsystem) if a vehicle subsystem does not respond within a threshold amount of time, ensuring the vehicle system 104 remains operational.

Boundary checks and rationality checks integrated into the safety integrity library 302 and the safety integrity library 304 further enhance security provided by the central control unit 118 (e.g., to at least one of the controlling unit 114 or the controlled unit 116). Boundary checks validate that data generated by, and operations of, the central control unit 118, and each vehicle subsystem connected thereto by the drive API 120 or the safety API 122, stay within acceptable limits (e.g., preventing issues such as buffer overflows, memory corruption, and so forth). Rationality checks ensure that data and system states (e.g., a state of a vehicle subsystem, a state of the central control unit 118, or data generated therefrom) make logical sense (e.g., verifying that speed and location data for the vehicle 102 are consistent and plausible).

Thus, by integrating the safety integrity library 302 into the drive API 120 and integrating the safety integrity library 304 into the safety API 122 included in each communication link of the network 206, the central control unit 118 ensures the vehicle system 104, and each subsystem 202 included therein, operates safely, reliably, and efficiently, adapting to the complex demands of real-world driving while maintaining the highest standards of safety and integrity (e.g., ASIL-D).

For instance, in the illustrated example of FIG. 3, interfacing with the central control unit 118 using both the drive API 120 and the safety API 122 (e.g., via communication link 110) causes the controlling unit 114 to compile the safety integrity library 302 and the safety integrity library 304. Consider an example scenario where operation of the vehicle 102 includes a request by the central control unit 118 for the controlling unit 114 to autonomously drive the vehicle 102 by maneuvering the vehicle 102 from a current location to a destination along one or more paths or vectors defined by the controlling unit 114. In response to such an example request from the central control unit 118, the controlling unit 114 issues at least one vehicle control command 306 to the central control unit 118. The controlling unit 114, for instance, communicates the at least one vehicle control command 306 along the communication link 110 using the drive API 120. The safety integrity library 304 of the safety API 122 causes the controlling unit 114 to transmit safety data (e.g., controlling unit safety data 308) to describe a current health and status of the controlling unit 114 to the central control unit 118 during operation of the vehicle system 104.

In implementations, the safety integrity library 304 causes the controlling unit 114 to constantly (e.g., while the central control unit 118 requests the controlling unit 114 to autonomously drive the vehicle 102, while the controlling unit 114 is generating the at least one vehicle control command 306, after the controlling unit 114 transmits the at least one vehicle control command 306 to the central control unit 118, and so forth) provide updated controlling unit safety data 308 to the central control unit 118. Similarly, in an example scenario where the controlled unit 116 interfaces with the central control unit 118 via the safety API 122, the safety integrity library 304 causes the controlled unit 116 to constantly provide controlled unit safety data 310 to the central control unit 118, which describes a current health and status of the controlled unit 116. As described herein, “constantly” providing data (e.g., the controlling unit safety data 308 and/or the controlled unit safety data 310) refers to communicating data at one or more defined intervals (e.g., every nanosecond, every microsecond, and so forth).

Alternatively or additionally, safety data (e.g., controlling unit safety data 308 and/or controlled unit safety data 310) is provided to the central control unit 118 by a vehicle subsystem in response to a status request 312 received from the central control unit 118. The safety integrity library 302 or the safety integrity library 304, for instance, includes at least one hook or service that causes the central control unit 118 to periodically (e.g., constantly, irregularly, in response to defined events, combinations thereof, and so forth) issue a status request 312 to one or more connected vehicle subsystems. The safety integrity library 302 causes the central control unit 118 to identify any instances of a subsystem failure from data communicated via the drive API 120 (e.g., the at least one vehicle control command 306).

Similarly, the safety integrity library 304 causes the central control unit 118 to identify any instances of a subsystem failure from data communicated via the safety API 122 (e.g., the controlling unit safety data 308 or the controlled unit safety data 310). In implementations, absent an indication of a vehicle subsystem failure, the central control unit 118 permits operation of the vehicle 102 to continue as directed by the controlling unit 114 (e.g., the central control unit 118 passes the at least one vehicle control command 306 as at least one actuation command 314 to the controlled unit 116 to effect autonomous driving of the vehicle 102).

Alternatively, in response to detecting a failure of at least one vehicle subsystem via data communicated by the drive API 120 and/or the safety API 122, the central control unit 118 is configured to take corrective action (e.g., to remedy the vehicle subsystem failure, to preserve a safety envelope of the vehicle 102, and so forth).

In implementations, failures of a vehicle subsystem are defined by the specific hooks and services of the safety integrity library 302 or the safety integrity library 304, which in turn are tailored by the central control unit 118 based on functionality of the vehicle subsystem. As a specific example, in an example implementation where the controlling unit 114 includes perception sensor devices 232, the safety integrity library 302 and the safety integrity library 304 are configured to include a perception group (e.g., a perception processing handler, a motion processing handler, and so forth) tailored for that specific vehicle subsystem. In this manner, the ongoing health of the specific vehicle subsystem and its components (e.g., sensors and processors) are reported to the central control unit 118.

For instance, in response to detecting a failure (e.g., a fault) with the controlling unit 114, the central control unit 118 issues a fault mitigation command 316 to the controlling unit 114. In some implementations, the fault mitigation command 316 represents a command for the controlling unit 114 to issue a corrected vehicle control command 306 (e.g., in response to detecting, using the safety integrity library 302, that a previously received vehicle control command 306 exceeds a safety threshold for the vehicle 102). In such implementations, the central control unit 118 monitors the controlling unit 114 to identify whether appropriate corrective action is taken by the controlling unit 114 in response to receiving the fault mitigation command 316. As a specific example, the central control unit 118 monitors the drive API 120 to determine whether a corrected vehicle control command 306 is issued by the controlling unit 114 within a threshold amount of time (e.g., 50 microseconds).

In another example implementation, in an instance where the vehicle system 104 includes redundant instances of the controlling unit 114, the fault mitigation command 316 represents a command by the central control unit 118 to transfer operations of the faulty controlling unit 114 to a non-faulty instance of the controlling unit 114 and for the faulty controlling unit 114 to reboot itself. In an extreme scenario where the controlling unit 114 fails to remedy a detected failure, the fault mitigation command 316 is representative of the central control unit 118 cutting power to the controlling unit 114 to prevent its failure from compromising safety of the vehicle 102.

In some implementations, corrective action taken by the central control unit 118 includes issuing an actuation command 314 to a controlled unit 116, where the actuation command 314 remedies one or more faults associated with a vehicle control command 306 received from the controlling unit 114. For instance, in response to detecting a failure (e.g., at the controlling unit 114 or in data of the at least one vehicle control command 306), the central control unit 118 issues actuation command 314 to cause the controlled unit 116 to perform controlled braking of the vehicle 102, perform a minimum risk maneuver for the vehicle 102, and so forth. In this manner, the higher integrity safety rating of the central control unit 118 (e.g., ASIL-D certification) is imparted on other edge devices of the vehicle, thereby uplifting an overall safety integrity level of the edge devices, despite one or more of the other edge devices not itself being certified at the higher safety integrity level.

In some implementations, the central control unit 118 is further configured to impart its high-integrity safety level on a vehicle subsystem even in a scenario where the vehicle subsystem is not communicatively coupled to the central control unit 118 by the drive API 120 or the safety API 122. For instance, consider an example scenario where the controlled unit 116 is not connected to the central control unit 118 using the safety API 122. In this example scenario, the controlled unit 116 is implemented in the vehicle system 104 as including a monitor 124 that is configured to report feedback data 318 via a communication link 320 that directly couples the monitor 124 to the central control unit 118.

Such feedback data 318 is reported independent of routing through a communication link coupling the controlled unit 116 to the central control unit 118, thereby enabling the central control unit 118 to trust a veracity of the feedback data 318 even in the presence of a failure of the controlled unit 116. In such an example scenario, the central control unit 118 uses the feedback data 318 to compare a current state of the controlled unit 116 against an expected state if the controlled unit 116 were to execute the actuation command 314 without failure. In response to detecting a discrepancy between the current state (e.g., as described by the feedback data 318) and the expected state of the controlled unit 116, the central control unit 118 infers that a failure has occurred and takes corrective action by performing controlled braking or causing the vehicle 102 to perform a minimum risk maneuver.

Having considered example systems for uplifting a safety integrity level of vehicle subsystems using APIs exposed by a central control unit, consider now example procedures to implement aspects of the techniques described herein.

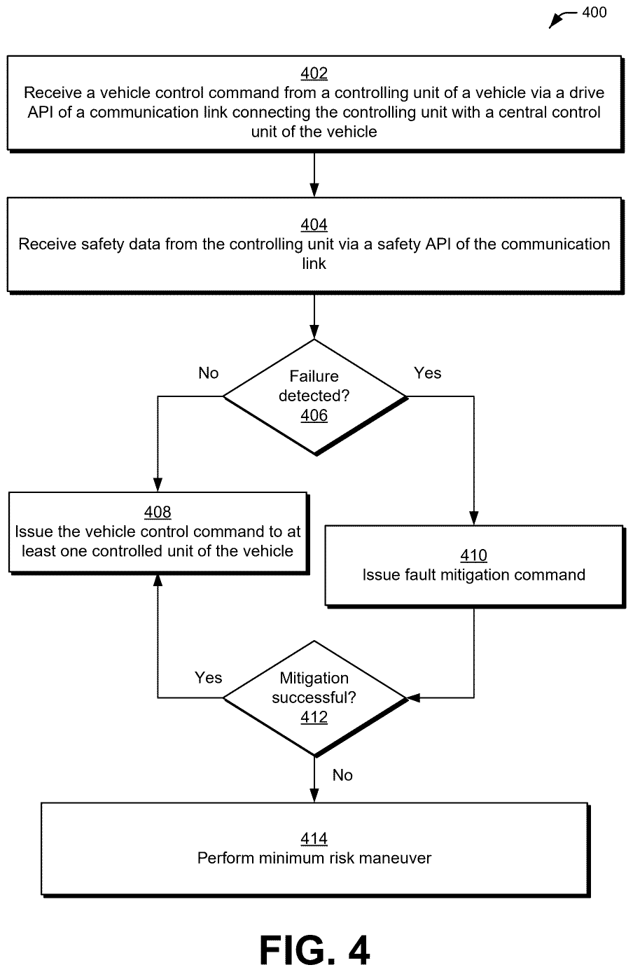

FIG. 4 depicts a procedure 400 in which a central control unit of a vehicle imparts a safety integrity level on a controlling unit of the vehicle. To begin, a vehicle control command is received from a controlling unit of a vehicle via a drive API of a communication link connecting the controlling unit with a central control unit of the vehicle (block 402). The central control unit 118, for instance, receives at least one vehicle control command 306 from the controlling unit 114 via the drive API 120.

Safety data is additionally received from the controlling unit via a safety API of the communication link (block 404). The central control unit 118, for instance, receives controlling unit safety data 308 from the controlling unit 114 via the drive API 120. Although depicted as being performed sequentially in the procedure 400, in some implementations operation of block 402 and block 404 occurs simultaneously (e.g., the central control unit 118 receives the at least one vehicle control command 306 and the controlling unit safety data 308 at the same time). Alternatively, in some implementations, the central control unit 118 receives the controlling unit safety data 308 prior to receipt of the at least one vehicle control command 306.

A determination is then made as to whether a failure is detected (block 406). The central control unit 118, for instance, via compilation of the safety integrity library 302 and the safety integrity library 304, is configured to identify whether data included in the at least one vehicle control command 306 and/or the controlling unit safety data 308 indicates failure of the controlling unit 114 (e.g., that a problem has occurred at the controlling unit 114 or that data generated by the controlling unit 114 is problematic). In response to not detecting a failure (e.g., a “No” determination at block 406), the vehicle control command is issued to at least one controlled unit of the vehicle (block 408). The central control unit 118, for instance, issues the at least one vehicle control command 306 as an actuation command 314 to the controlled unit 116, such that the controlled unit 116 moves the vehicle 102 along one or more paths or vectors as defined by the controlling unit 114.

Alternatively, in response to detecting a failure (e.g., a “Yes” determination at block 406), a fault mitigation command is issued (block 410). The central control unit 118, for instance, issues fault mitigation command 316 to the controlling unit 114. A determination is then made as to whether the fault mitigation was successful (block 412). The central control unit 118, for instance, determines whether a corrected at least one vehicle control command 306 issued in response to a fault mitigation command 316 corrects the failure detected at block 406 within a threshold amount of time. In response to determining that the failure was successfully mitigated (e.g., a “Yes” determination at block 412), operation returns to block 408 and the corrected at least one vehicle control command 306 is issued to the controlled unit 116 as the actuation command 314.

In response to determining that the failure mitigation was unsuccessful (e.g., a “No” determination at block 412), a minimum risk maneuver is performed (block 414). The central control unit 118, for instance, transmits at least one actuation command 314 that causes one or more controlled units 116 to perform controlled braking to stop the vehicle, perform one or more maneuvers to divert a motion path of the vehicle 102 from objects or other vehicles, or motion paths thereof, in the environment 100, or combinations thereof. In this manner, the central control unit 118 is configured to uplift a safety integrity level on a controlling unit of the vehicle 102.

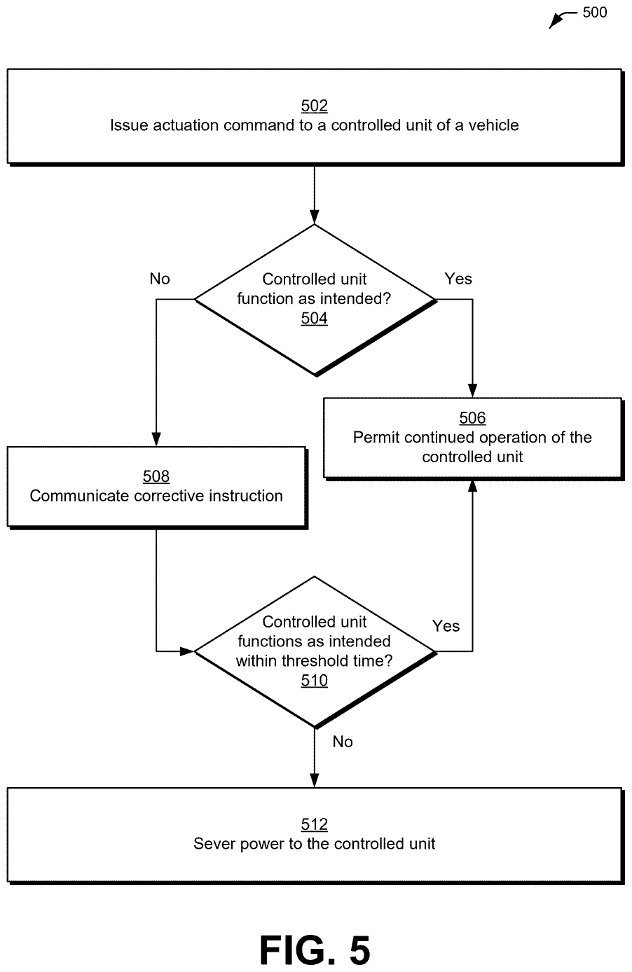

FIG. 5 depicts a procedure 500 in which a central control unit of a vehicle imparts a safety integrity level on a controlled unit of the vehicle. To begin, an actuation command is issued to a controlled unit of a vehicle (block 502). The central control unit 118, for instance, transmits at least one actuation command 314 to the controlled unit 116 for carrying out a vehicle operation (e.g., applying positive torque to a wheel, braking, actuating a steering motor control to change a motion vector of the vehicle 102, activating a turn signal, turning on headlights, shifting gears, etc.).

A determination is then made as to whether the controlled unit is functioning as intended (block 504). The central control unit 118, for instance, receives controlled unit safety data 310 via the safety API 122 by which the central control unit 118 and the controlled unit 116 are communicatively coupled. In implementations, the controlled unit safety data 310 provides status information for the controlled unit 116 (e.g., absolute position information, internal health reporting information, sensor status data, etc.). The central control unit 118 analyzes the controlled unit safety data 310 using the safety integrity library 304 to identify whether the controlled unit 116 is executing the actuation command 314 as intended.

In response to determining that the controlled unit is functioning as intended (e.g., a “Yes” determination at block 504), continued operation of the controlled unit is permitted (block 506). The central control unit 118, for instance, allows the controlled unit 116 to continue operating without intervention. Alternatively, in response to determining that the controlled unit is not functioning as intended (e.g., a “No” determination at block 504), a corrective instruction is communicated (block 508). The central control unit 118, for instance, issues an additional actuation command 314 that is tailored to correct the identified discrepancy between an observed function of the controlled unit 116 and its expected function (e.g., as expected by the central control unit 118 to result from safe and correct execution of the original actuation command 314).

A determination is then made as to whether the controlled unit functions as intended within a threshold time (block 510). The central control unit 118, for instance, monitors functionality of the controlled unit 116 to identify whether an observed failure is remedied within a threshold time defined by the safety integrity library 304 (e.g., 10 microseconds). In response to determining that the controlled unit resumes functioning as intended within the threshold time (e.g., a “Yes” determination at block 510), operation of procedure 500 returns to block 506 and the controlled unit is permitted to continue operation. Alternatively, in response to determining that the controlled unit does not resume its intended functionality within the threshold time (e.g., a “No” determination at block 510), power to the controlled unit is severed (block 512). The central control unit 118, for instance, causes the controlled unit 116 to cease functioning by cutting off a power supply to the controlled unit 116. In some implementations, the central control unit 118 further causes the vehicle to perform a minimum risk maneuver (e.g., as described above with respect to block 414 of FIG. 4).

Many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the vehicle system 104, control system 108, vehicle subsystem 106, controlling unit 114, controlled unit 116, and central control unit 118) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a DSP, a GPU, a parallel accelerated processor, a plurality of microprocessors, one or more microprocessors in association with a DSP core, a controller, a microcontroller, Application Specific Integrated Circuits (ASICs), FPGAs, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a ROM, a RAM, a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a central control unit configured to maintain a global safety state of a vehicle by:
providing a drive application programming interface (API) that enables a controlling unit to issue vehicle control commands for autonomously driving the vehicle; and
providing a safety API that enables the central control unit to receive information describing a health status of the controlling unit of the vehicle;
a communication link that couples the central control unit and the controlling unit using the drive API and the safety API; and
the controlling unit configured to autonomously drive the vehicle by sending at least one vehicle control command to the central control unit for routing to a controlled unit of the vehicle.

2. The system of claim 1, wherein the controlling unit is configured to autonomously drive the vehicle independent of one or more human inputs after initiating travel along a route.

3. The system of claim 1, wherein the controlling unit is configured to autonomously drive the vehicle by defining a motion path for the vehicle and one or more vectors for moving the vehicle along the motion path.

4. The system of claim 1, the central control unit further configured to identify a fault in the system based on data received from the controlling unit via one or more of the drive API or the safety API, wherein the at least one vehicle control command is included in the vehicle control commands routed to the controlled unit of the vehicle responsive to not identifying the fault in the system.

5. The system of claim 1, the central control unit further configured to:
identify a fault in the system based on data received from the controlling unit via one or more of the drive API or the safety API; and
issue a fault mitigation command to the controlling unit in response to identifying the fault in the system, the fault mitigation command causing the controlling unit to generate a corrected vehicle control command that remedies the fault.

6. The system of claim 5, the central control unit further configured to cause the controlled unit to perform corrective action in response to identifying that the corrected vehicle control command fails to remedy the fault.

7. The system of claim 6, wherein the corrective action comprises causing the controlled unit to perform controlled braking.

8. The system of claim 6, wherein the corrective action comprises causing the controlled unit to perform a minimum risk maneuver that diverts a motion path of the vehicle from at least one object.

9. The system of claim 6, wherein the corrective action comprises the central control unit severing power from the controlled unit.

10. The system of claim 6, wherein the corrective action comprises activating a redundant instance of the controlled unit and causing the controlled unit to reboot while the redundant instance of the controlled unit executes the at least one vehicle control command.

11. The system of claim 1, wherein the drive API and the safety API each include a library of hooks and services that maintain a health of the controlling unit at an ASIL-D integrity level.

12. The system of claim 11, wherein the controlling unit is not certified at the ASIL-D integrity level.

13. The system of claim 11, wherein the library of integrity hooks and services include instructions that communicate information describing the health of at least one component of the controlling unit at defined intervals during operation of the vehicle.

14. A method comprising:
receiving, by a central control unit of an autonomous vehicle, a vehicle control command from a controlling unit of the autonomous vehicle via a drive application programming interface (API) connecting the central control unit and the controlling unit;
receiving, by the central control unit, controlling unit safety data from the controlling unit via a safety API connecting the central control unit and the controlling unit;
identifying, by the central control unit, a failure associated with the controlling unit by:
processing the vehicle control command using a safety integrity library integrated into the drive API; or
processing the controlling unit safety data using a safety integrity library integrated into the safety API; and
causing, by the central control unit, performance of a corrective action in response to detecting the failure associated with the controlling unit.

15. The method of claim 14, wherein causing performance of the corrective action comprises transmitting an actuation command to at least one controlled unit of the autonomous vehicle that causes controlled braking of the autonomous vehicle.

16. The method of claim 14, wherein causing performance of the corrective action comprises transmitting a fault mitigation command to the controlling unit, the fault mitigation command causing the controlling unit to transmit a corrected vehicle control command to the central control unit within a threshold amount of time.

17. The method of claim 14, wherein the drive API and the safety API each include a library of hooks and services that maintain a health of the controlling unit at an ASIL-D integrity level, wherein the central control unit is certified at the ASIL-D integrity level and the controlling unit is not certified at the ASIL-D integrity level.

18. The method of claim 14, wherein causing performance of the corrective action comprises causing at least one controlled unit of the autonomous vehicle to perform a minimum risk maneuver that maintains a safety envelope of the autonomous vehicle.

19. The method of claim 14, wherein the central control unit is further configured to identify the failure associated with the controlling unit based on feedback data received from at least one monitor disposed within a controlled unit of the autonomous vehicle, wherein the failure is identified by comparing the feedback data to an expected response of the controlled unit from performing the vehicle control command.

20. A computer-readable storage medium storing instructions that are executed by at least one processor of a central control unit of an autonomous vehicle to:
receive a vehicle control command from a controlling unit of the autonomous vehicle via a drive application programming interface (API) connecting the central control unit and the controlling unit;
receive controlling unit safety data from the controlling unit via a safety API connecting the central control unit and the controlling unit;
identify a failure associated with the controlling unit based on at least one of processing the vehicle control command using a safety integrity library integrated into the drive API processing the controlling unit safety data using a safety integrity library integrated into the safety API; and
perform a corrective action in response to detecting the failure associated with the controlling unit.
